(19) United States
(12) Patent Application Publication
(10) Pub. No.: US 2011/0056766 A1
(43) Pub. Date: Mar. 10, 2011

(54) Ladder tool bag the "LTB"

(76) Inventors: Anthony Maglieri, Camarillo, CA (US); Eddie Eaton, Joliet, IL (US)

(21) Appl. No.: 12/546,569

(22) Filed: Sep. 10, 2009

(51) Int. Cl. E06C 7/14

(52) U.S. Cl. 182/129

(57) ABSTRACT

The “LTB” is designed to attach to an “A” frame ladder. The concept consists of stopping the use of the “A” frame ladder warning rung and to utilize the warning rung space to store tools.

The “LTB” has a specific design to allow attachment to an “A” frame ladder. This design is geared toward the existing design of all “A” frame ladders. The “LTB” will help assure ladder safety as well as tool storage and organization.

### BACKGROUND OF THE INVENTION

The field of endeavor is pertaining to “A” frame ladder safety and tool storage. All “A” frame ladders have a warning label on the top rung. This label is to notify ladder users of the possibility of losing your balance if this warning rung is used to stand on. OSHA will write infactions for the use of this warning rung which may also incur a monetary fine to the company employing the ladder user. There is limited space on the ladder top cap for tool storage as this can result in falling tools or forcing the ladder user to go up and down the ladder many times. It is these factors from first hand experience that have brought to light the concept of the “LTB”.

### BRIEF SUMMARY OF THE INVENTION

The concept of the “LTB” is to stop “A” frame ladder warning rung accidents and to utilize the “A” frame ladder warning rung space to store tools. The “LTB” offers “A” frame ladder user(s) a specifically designed portable toolbag or toolbox that will attach to any “A” frame ladder warning rung to avoid the negative issues of losing balance, falling tools & OSHA fines.

The “LTB” is designed to rest on the “A” frame ladder warning rung and attach to the rear ladder frame supports . The “LTB” is designed to close or collapse while attached on the “A” frame ladder to allow for “A” frame ladder transport or storage.

The distinct design of the “LTB” will allow the “A” frame ladder user(s) to rely on storage for tools as well as safety by not having access to stand on the “A” frame ladder warning rung.

### BRIEF DESCRIPTION OF THE SEVERAL VIEWS OF DRAWINGS

FIG. 1 is a front and side view of the “LTB” installed on an “A” frame ladder. FIG. 1 also shows where the “LTB” attaches to the “A” frame ladder and where the access to the tools is located on the “LTB”.

FIG. 2 is a rear and side view of the “LTB” not attached to the A” frame ladder. FIG. 2 also shows the top zippered access and where the nylon snaps straps are located on the “LTB”.

FIG. 3 is a front and side view of the “LTB” not attached to the “A” frame ladder. FIG. 3 also shows the top zippered access and front zippered access points.

FIG. 4 is a rear and side view of the “LTB” not attached to the “A” frame ladder. FIG. 3 also shows the location of the top and bottom nylon velcro snap straps.

FIG. 5 is a view of the “LTB” open or un-collapsed dimensions. FIG. 5 also shows the Height, length and width of the open “LTB”.

FIG. 6 is a view of the “LTB” collapsed dimensions. FIG. 6 also shows the Height, length and width of the collapsed “LTB”.

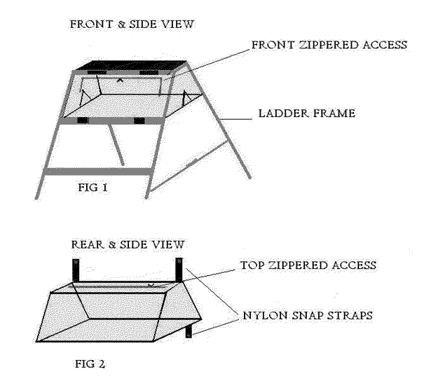

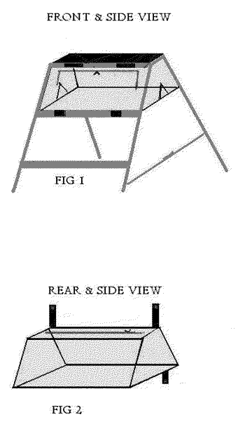

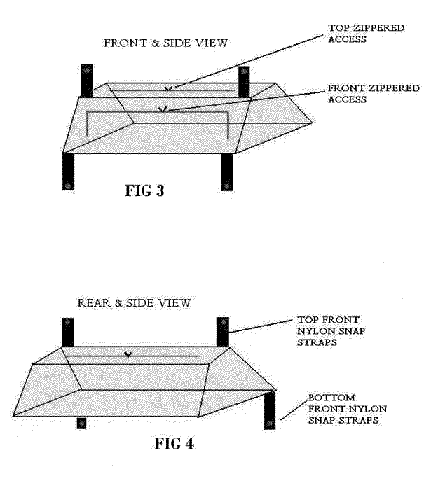

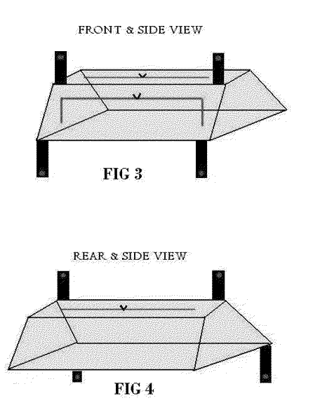

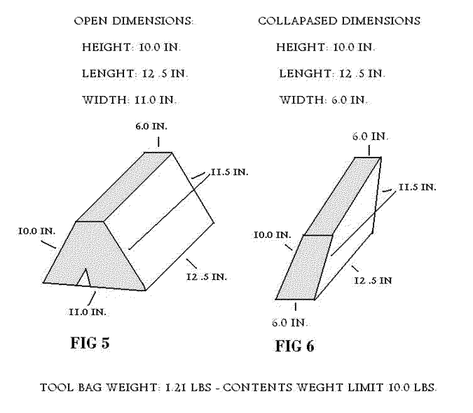

The drawing of the dimensions also shows the weight of the “LTB” and the contents weight limit.

### DETAILED DESCRIPTION OF THE INVENTION

The “LTB” invention is a portable canvas tool bag or plastic, wood, metal or composite molded toolbox. The concept of the “LTB” is to stop “A” frame ladder warning rung accidents and to utilize the “A” frame ladder warning rung space to store tools.

The “LTB” is designed to rest on an “A” frame ladder warning rung and attach to the rear ladder frame supports with nylon velcro snap straps The nylon Velcro snap straps allow for easy installation and removal as well as to accommodate for different “A” frame ladder rear support dimensions. The “LTB” has plastic inserts inside the canvas fabric at the front, bottom and rear walls to give stability. The “LTB” has a crease or fold in the bottom plastic insert to allow for closure while attached on the “A” frame ladder. This design allows the “LTB” to be attached on the “A” frame ladder during ladder closure for transport or storage.

The “LTB” dimensions have been established to accommodate a wide variety of “A” Frame ladders due to an abundance of “A” frame ladder manufacturers. The “LTB” design has a standard measurement of 12.5 inches in length, 11 inches in width and 10 inches in height. These measurements accommodate all “A” frame ladders available to the public.

The collapsed measurements are 12.5 inches in length, 6 inches in width and 10 inches in height.

The “LTB” has a top zippered access to load tools while unattached to the “A” frame ladder and a front zippered access to allow access to the tools while installed on the “A” frame ladder. The “LTB” has 16interior pockets to store tools and a plastic container to hold misc. screws. The “LTB” has 8 exterior Pockets to hold tools while working on the “A” frame ladder.

1. The concept of “LTB” is to help “A” frame ladder users stop the risk of “A” frame ladder warning rung accidents and to utilize the “A” frame ladder warning rung space to store tools. The “LTB” will help assist in “A” frame ladder safety and tool storage and organization. Use of the “LTB” will give any foreman peace of mind that their employee will not have an “A” frame ladder warning rung accident nor receive an OSHA fine for use of the “A” frame ladder waning rung. Use of the “LTB” may also lower construction company insurance rates.
